(19) United States
(12) Patent Application Publication
(10) Pub. No.: US 2025/0232171 A1
(43) Pub. Date: Jul. 17, 2025

(54) METHOD, ELECTRONIC DEVICE, AND COMPUTER PROGRAM PRODUCT FOR WATERMARK PROCESSING

(71) Applicant: Dell Products L.P., Round Rock, TX (US)

(72) Inventors: Zijia Wang, Weifang (CN); Qiang Chen, Shanghai (CN); Zhisong Liu, Shenzhen (CN); Zhen Jia, Shanghai (CN)

(21) Appl. No.: 18/439,941

(22) Filed: Feb. 13, 2024

(30) Foreign Application Priority Data
Jan. 12, 2024 (CN) 202410054967.1

(51) Int. Cl. G06N 3/08; G06N 3/044

(52) U.S. Cl. CPC G06N 3/08; G06N 3/044

(57) ABSTRACT

Embodiments of the present disclosure provide a method, an electronic device, and a computer program product for processing a watermark of a neural network model. The method includes: embedding a parameter component watermark into a first parameter of a neural network model to generate a second parameter of the neural network model; embedding an input component watermark into a first input to the neural network model to generate a second input to the neural network model; embedding a gradient component watermark into a first model gradient of the neural network model to generate a second model gradient of the neural network model; and training the neural network model based on the second parameter, the second input, and the second model gradient to generate a trained neural network model.

### RELATED APPLICATION

The present application claims priority to Chinese Patent Application No. 202410054967.1, filed Jan. 12, 2024, and entitled “Method, Electronic Device, and Computer Program Product for Watermark Processing,” which is incorporated by reference herein in its entirety.

### FIELD

Embodiments of the present disclosure relate to the field of computer processing, and more particularly to a method, an electronic device, and a computer program product for processing a watermark of a neural network model.

### BACKGROUND

Currently, in the field of artificial intelligence, neural network models have been widely applied in various fields. Correspondingly, neural network models can provide substantial commercial value for their respective owners, in return for the significant investments required to develop such models. In these and other situations involving neural network models, it is important to provide a mechanism that is capable of protecting the intellectual property associated with neural network models, so that when a neural network model is attacked, an effective model verification solution can be provided for the model owner to take an appropriate measure to respond to such attacks.

### SUMMARY

Embodiments of the present disclosure provide a method, an electronic device, and a computer program product for processing a watermark of a neural network model.

According to a first aspect of the present disclosure, a method for processing a watermark of a neural network model is provided. The method includes embedding a parameter component watermark into a first parameter of a neural network model to generate a second parameter of the neural network model, embedding an input component watermark into a first input to the neural network model to generate a second input to the neural network model, embedding a gradient component watermark into a first model gradient of the neural network model to generate a second model gradient of the neural network model, and training the neural network model based on the second parameter, the second input, and the second model gradient to generate a trained neural network model.

According to a second aspect of the present disclosure, an electronic device is provided. The electronic device includes at least one processor, and a memory coupled to the at least one processor and having instructions stored therein, wherein the instructions, when executed by the at least one processor, cause the electronic device to perform actions. The actions include embedding a parameter component watermark into a first parameter of a neural network model to generate a second parameter of the neural network model, embedding an input component watermark into a first input to the neural network model to generate a second input to the neural network model, embedding a gradient component watermark into a first model gradient of the neural network model to generate a second model gradient of the neural network model, and training the neural network model based on the second parameter, the second input, and the second model gradient to generate a trained neural network model.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform steps of the method in the first aspect of the present disclosure.

### BRIEF DESCRIPTION OF THE DRAWINGS

By the following Detailed Description of example embodiments of the present disclosure, provided herein with reference to the accompanying drawings, the above and other objectives, features, and advantages of the present disclosure will become more apparent, wherein identical reference numerals generally represent identical components in the example embodiments of the present disclosure, and in which:

FIG. 1 is a schematic diagram of an example system in which a device and/or a method according to an embodiment of the present disclosure can be implemented;

FIG. 2 is a flow chart of a method for processing a watermark of a neural network model according to an embodiment of the present disclosure;

FIG. 3 is a block diagram of determining a verification mode by using an adaptive controller according to an embodiment of the present disclosure;

FIG. 4 is a flow chart of a method for extracting a watermark of a to-be-verified neural network model as extracted data according to an embodiment of the present disclosure;

FIG. 5 is a flow chart of a method for verifying a neural network model according to an embodiment of the present disclosure; and

FIG. 6 is a block diagram of an example device suitable for implementing embodiments of the present disclosure.

In various accompanying drawings, identical or corresponding reference numerals represent identical or corresponding parts.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In the field of artificial intelligence, with the widespread application of neural network models, intellectual property protection for the neural network models has also received more and more attention and research. The neural network model watermarking technology has been proposed and has currently become the main technology for protecting the intellectual property of neural network models in the field of deep learning.

Model watermarking is a technology that protects the intellectual property of a neural network model by embedding a secret signature in a parameter of the neural network model or in an input to/output from the model, and can be used for verifying ownership of the neural network model. Currently, the model watermarking technology is mainly classified into two types: a black box model watermarking technology and a white box model watermarking technology. The black box model watermarking technology does not need to access a parameter of a model, but is applicable to inputs to and outputs from the model. Different from this, the white box watermarking technology needs to access a parameter of a model and directly or indirectly modifies the parameter of the model to embed a watermark.

The black box model watermarking technology may be further classified into two types: an input-based type and an output-based type. The input-based technology is a technology that embeds a watermark into input data by adding noise to the input data (such as an image or text) or modifying pixels or characters. The output-based technology embeds a watermark into an output label or a prediction by changing or adding some labels or values. The input-based technology is more robust against a model extraction attack, where an attacker may attempt to clone the model by using a large number of input queries and collecting corresponding outputs. The output-based technology is more robust against a model fine-tuning attack, where an attacker attempts to erase or modify a watermark by re-training the model using new data.

The white box model watermarking technology may also be classified into two types: a parameter-based technology and a gradient-based technology. The parameter-based technology embeds a watermark into a parameter of a model by adding noise to the parameter (such as a weight or bias) of the model or by modifying a parameter value of the model. The gradient-based technology embeds a watermark into a gradient of a model by changing or increasing the gradient of the model. The parameter-based technology is more robust against a model compression attack, where an attacker attempts to reduce the size of the model or the complexity of the model by trimming or quantifying parameters of the model. The gradient-based technology is more robust against a model inversion attack, where an attacker attempts to restore training data from the model by computing an inverse gradient.

Although the current model watermarking has made great progress, there are still some problems. For example, the current model watermarking technology only uses the black box model watermarking technology or the white box model watermarking technology, which leads to a lack of flexibility and adaptability in the current model watermarking technology. For example, if an attacker focuses on the specific weakness of a specific method, it would be difficult for the current model watermarking technology to respond. In addition, the current model watermarking technology typically embeds a watermark completely into a model component of a neural network model, and therefore, it cannot effectively improve the anti-attack ability of the model.

To at least solve the above and other potential problems, embodiments of the present disclosure provide a method for processing a watermark of a neural network model. The method includes: generating a second parameter of the neural network model by embedding a parameter component watermark into a first parameter of the neural network model. The method further includes: generating a second input to the neural network model by embedding an input component watermark into a first input to the neural network model. The method further includes: generating a second model gradient of the neural network model by embedding a gradient component watermark into a first model gradient of the neural network model. The method further includes: training the neural network model based on the second parameter, the second input, and the second model gradient to generate a trained neural network model. Through this method, the anti-attack ability of the neural network model can be effectively improved, and the flexibility and adaptability of processing the watermark of the neural network model can also be significantly improved.

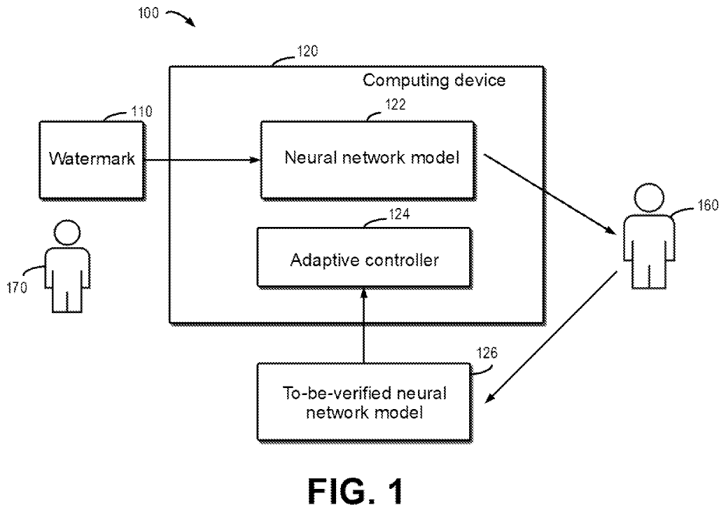

Illustrative embodiments of the present disclosure will be further described in detail with reference to the accompanying drawings below. FIG. 1 is a schematic diagram of an example system 100 in which an embodiment of the present disclosure can be implemented.

The example system 100 includes a computing device 120, and the computing device 120 includes a neural network model 122. The neural network model 122 may be a trained neural network model obtained through training. The trained neural network model 122 according to embodiments of the present disclosure may be used for implementing various tasks, and the structure of the neural network model and specific tasks implemented are not limited in the present disclosure.

The computing device 120 may include, but is not limited to, a personal computer, a server computer, a handheld or laptop device, a mobile device (such as a mobile phone, a personal digital assistant (PDA), and a media player), a multiprocessor system, a consumer electronic product, a wearable electronic device, a smart home device, a minicomputer, a mainframe computer, an edge computing device, a distributed computing environment including any of the above systems or devices, and the like.

In some embodiments, the computing device 120 may obtain the trained neural network model 122 by training a to-be-trained neural network model. In the training process, the computing device 120 may add a watermark 110 to the to-be-trained neural network model, and then train the to-be-trained neural network model having the watermark 110 added, thereby obtaining the trained neural network model 122. Therefore, the trained neural network model 122 obtained by the computing device 120 is a neural network model embedded with the watermark 110. Therefore, an effective model ownership verification solution may be provided to an owner 170 of the neural network model 122 when the neural network model 122 is attacked (such as being tampered with or stolen) by an attacker 160, so that the owner 170 of the model can take an appropriate measure to respond to the attack of the attacker 160, thereby achieving intellectual property protection for the trained neural network model 122.

In some embodiments, the watermark 110 according to embodiments of the present disclosure includes split watermarking. The split watermarking may include a parameter component watermark, an input component watermark, and a gradient component watermark. In some embodiments, the split watermarking may include a parameter component watermark, an input component watermark, a gradient component watermark, and an output component watermark. The computing device 120 may embed the parameter component watermark into a first parameter of a to-be-trained neural network model to generate a second parameter of the to-be-trained neural network model, embed the input component watermark into a first input to the to-be-trained neural network model to generate a second input to the to-be-trained neural network model, and embed the gradient component watermark into a first model gradient of the to-be-trained neural network model to generate a second model gradient of the to-be-trained neural network model. The computing device 120 further trains the to-be-trained neural network model based on the second parameter, the second input, and the second model gradient to generate the trained neural network model 122.

By splitting the watermark 110 into three levels of components (such as the parameter component watermark, the input component watermark, and the gradient component watermark), and embedding the three levels of component watermarks respectively into corresponding components of the to-be-trained neural network model, it is necessary during verification to extract watermarks from a plurality of components for verification, thereby increasing the security and robustness of the watermark. In addition, the method also effectively utilizes complementary technologies to protect various parts of the model, such as the parameter, the input, and the gradient. Therefore, the method can effectively enhance the anti-attack ability of the neural network model, and can further significantly improve the flexibility and adaptability of processing a watermark of the neural network model.

In addition, in some embodiments, the method of processing a watermark according to embodiments of the present disclosure may also perform watermark extraction on a to-be-verified neural network model 126, so as to perform verification on the to-be-verified neural network model 126 in terms of, for example, ownership, so as to verify whether an owner of the to-be-verified neural network model 126 is the owner 170 of the trained neural network model 122.

In some embodiments, as shown in FIG. 1, the computing device 120 may further include an adaptive controller 124, and the adaptive controller 124 is used for determining a verification mode based on information from the to-be-verified neural network model 126. As shown in FIG. 1, the attacker 160 attacks the neural network model (the trained neural network model 122 or another network model), such as tampering with the model or stealing the model, and generates the to-be-verified neural network model 126. In order to achieve the verification of the to-be-verified neural network model 126, the computing device 120 may receive output data, a network parameter, and an attack indicator of the to-be-verified neural network model 126, and determine the verification mode by using the adaptive controller 124 in the computing device 120.

The computing device 120 may further extract watermarks in input data, output data, and a network parameter of the to-be-verified neural network model 126, and generate extracted data corresponding to the input data, the output data, and the network parameter, respectively. The computing device 120 may further select, according to the determined verification mode, extracted data corresponding to the determined verification mode, and compare the selected extracted data with a physical unclonable function (PUF) response in the device (such as the computing device 120 in FIG. 1) where the to-be-trained neural network model is located, so as to generate a verification result. The computing device 120 may further determine, according to the verification result, the ownership of the to-be-verified neural network model 126, for example, whether the ownership of the to-be-verified neural network model 126 is owned by the owner of the trained neural network model 122. For example, when the extracted data is equal to the PUF response in the computing device 120, the computing device 120 may determine that the ownership of the to-be-verified neural network model 126 is owned by the owner of the trained neural network model 122.

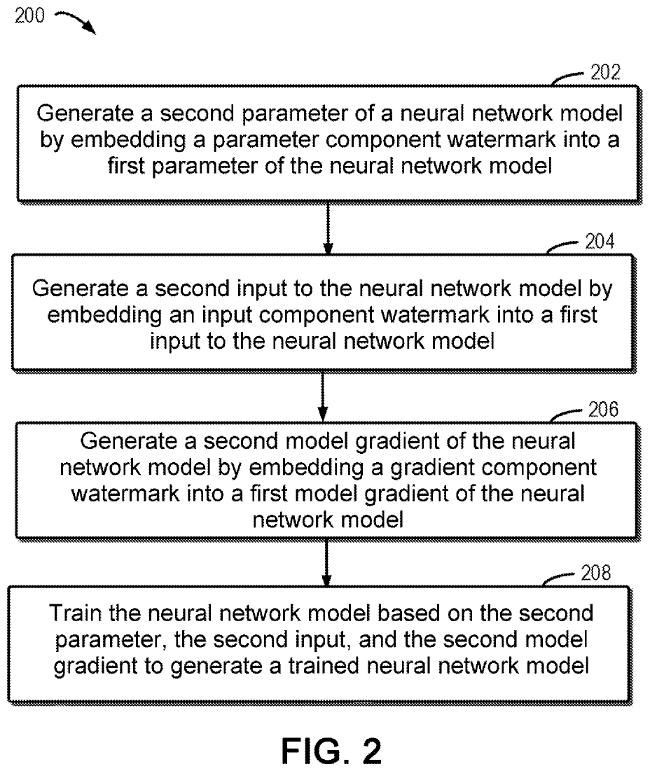

A block diagram of the example system 100 in which an embodiment of the present disclosure can be implemented has been described above with reference to FIG. 1. A method for processing a watermark of a neural network model according to an embodiment of the present disclosure is described below with reference to FIG. 2. FIG. 2 is a flow chart of a method 200 for processing a watermark of a neural network model according to an embodiment of the present disclosure. The method 200 may be performed at the computing device 120 in FIG. 1 and any suitable computing device. In addition, the numbering in the flow chart does not indicate the order in which these steps are performed. Some or all of these steps may be performed in parallel, or the performing order may be exchanged with each other, which is not limited in the present disclosure.

At block 202, the computing device 120 may generate a second parameter of the neural network model by embedding a parameter component watermark into a first parameter of the neural network model (for example, a to-be-trained neural network model).

As mentioned above, based on the watermark processing method according to embodiments of the present disclosure, the watermark may be split into three levels of components: a parameter component watermark, an input component watermark, and a gradient component watermark. The parameter component watermark is embedded into a parameter of a to-be-trained neural network model (such as an initial parameter or an intermediate parameter during training), the input component watermark is embedded into an input to the to-be-trained neural network model, and the gradient component watermark is embedded into a model gradient of the to-be-trained neural network model. Thus, the three levels of components may be respectively embedded into the corresponding components of the to-be-trained neural network model. Correspondingly, when the computing device 120 performs verification on the to-be-verified neural network model, watermarks of a plurality of components need to be extracted, thereby increasing the security and robustness of the watermark.

As indicated previously, the computing device 120 at block 202 may generate the second parameter of the neural network model (for example, the to-be-trained neural network model) by embedding the parameter component watermark into the first parameter of the neural network model (for example, the to-be-trained neural network model). In some embodiments, the first parameter includes a parameter of the to-be-trained neural network model, such as the initial parameter or an intermediate parameter obtained during the training process. By embedding the parameter component watermark into the first parameter, the second parameter of the to-be-trained neural network model may be obtained, and the second parameter is a parameter with the watermark embedded. For example, the second parameter may include a model parameter of a neural network with noise added. In some embodiments, the model parameter of a neural network may include a weight and/or bias of the neural network model (for example, the to-be-trained neural network model).

In some embodiments, the computing device 120 may embed the parameter component watermark into the first parameter by using the parameter-based watermarking technology, thereby generating the second parameter, that is, a parameter with the parameter component watermark embedded. It is to be understood that the computing device 120 may further use any other suitable technology to embed the parameter component watermark into the first parameter to generate the second parameter, and the watermark embedding technology used is not limited in the present disclosure.

At block 204, the computing device 120 may generate a second input to the neural network model by embedding the input component watermark into a first input to the neural network model. In some embodiments, the first input may include training input data for training the neural network model, such as an image training set or a text training set, which is not limited in the present disclosure. The computing device 120 may embed the input component watermark into the first input to the neural network model, thereby generating the second input to the neural network model. The second input is the input data with the input component watermark embedded, for example, the input training data with a watermark added.

In some embodiments, the computing device 120 may embed the input component watermark into the first input by using the input-based watermarking technology, thereby generating the second input, that is, an input with the input component watermark embedded. It is to be understood that the computing device 120 may also embed the input component watermark into the first input by using any other suitable technology to generate the second input, and the watermark embedding technology used is not limited in the present disclosure.

At block 206, the computing device 120 may generate a second model gradient of the neural network model (for example, the to-be-trained neural network model) by embedding the gradient component watermark into a first model gradient of the neural network model (for example, the to-be-trained neural network model). The first model gradient of the neural network model may include a gradient set for the trained neural network model, and correspondingly, the second model gradient may include a gradient set with the gradient component watermark embedded.

In some embodiments, the computing device 120 may embed the gradient component watermark into the first model gradient by using the gradient-based watermark technology, so as to generate the second model gradient, that is, a model gradient with the input gradient watermark embedded. It is to be understood that the computing device 120 may also embed the gradient component watermark into the first model gradient by using any other suitable technology to generate the second model gradient, and the watermark embedding technology used is not limited in the present disclosure.

At block 208, the computing device 120 may train the neural network model based on the second parameter obtained at the block 202, the second input obtained at block 204, and the second model gradient obtained at block 206, so as to generate the trained neural network model 122. In some embodiments, the computing device 120 may select an appropriate training method to train the to-be-trained neural network model according to a task to be achieved by the to-be-trained neural network model, and the specific training method is not limited in the present disclosure.

Advantageously, in the method for processing a watermark of a neural network model according to embodiments of the present disclosure, by embedding three levels of components respectively into the corresponding components of the to-be-trained neural network model, it is necessary during verification to extract watermarks from a plurality of components for verification, thereby increasing the security and robustness of the watermark. The method may also effectively enhance the anti-attack ability of the neural network model, and can further significantly enhance the flexibility and adaptability of processing the watermark of the neural network model.

In addition, processing the watermark in the neural network model is described in the previous text by taking three levels of components as an example; however, in some embodiments, the number of component watermarks may be greater than or less than three, for example, two or four or more. For example, in the case of two component watermarks, a combination of any two component watermarks from the parameter component watermark, the input component watermark, and the gradient component watermark may be used, which is not limited in the present disclosure. For another example, in the case of four component watermarks, the component watermarks may further include an output component watermark. Correspondingly, the computing device 120 may generate a second output from the to-be-trained neural network model by embedding the output component watermark into a first output from the to-be-trained neural network model. In some embodiments, the first output may include target output data corresponding to the input training data for training the neural network model. The computing device 120 may embed the output component watermark into the first output from the to-be-trained neural network model, thereby generating the second output from the to-be-trained neural network model. The second output is an output with the output component watermark embedded, for example, the target output data for training the neural network model with a watermark added.

It will be understood by those skilled in the art that in the method for processing a watermark of a neural network model according to embodiments of the present disclosure, other various types of component watermarks may also be used without being limited to the component watermarks described in the above examples, which are not limited in the present disclosure.

The flow chart of the method 200 for processing a watermark of a neural network model according to an embodiment of the present disclosure is described above with reference to FIG. 2. The example generation methods of split component watermarks, that is, the parameter component watermark, the input component watermark, and the gradient component watermark will be specifically described below.

In some embodiments, the parameter component watermark, the input component watermark, and the gradient component watermark may be generated in combination with a parameter that characterizes a hardware security function, such as the PUF response. The PUF response may be a unique and unpredictable response generated based on physical characteristics and changes of hardware. The PUF response may be used for generating a hardware signature, and the signature may be used as an additional function to assist in generating the parameter component watermark, the input component watermark, and the gradient component watermark, and for verifying the watermark.

In some embodiments, the computing device 120 may determine a random seed based on the PUF response in the device where the to-be-trained neural network model is located. In some embodiments, the random seed is used for generating the parameter component watermark, the input component watermark, and the gradient component watermark. When the to-be-trained neural network model is arranged on the computing device 120 (as shown in FIG. 1) for local training, the PUF response may be a PUF response in the computing device 120. When the to-be-trained neural network model is arranged on a remote device R (for example, the computing device 120 performs remote training on the to-be-trained neural network model), the PUF response may be a PUF response of the remote device R.

In some embodiments, the computing device 120 may generate the parameter component watermark based on the first parameter of the neural network model (for example, the to-be-trained neural network model) and the random seed determined based on the PUF response in the device where the neural network model is located. The computing device 120 may generate the parameter component watermark by using various suitable methods based on the first parameter and the random seed, and the specific generation method of the parameter component watermark is not limited in the present disclosure.

In some embodiments, the computing device 120 may generate the input component watermark based on the first input (for example, an input training dataset for training the to-be-trained neural network model) of the neural network model (for example, to-be-trained neural network model) and the random seed determined based on the PUF response in the device where the neural network model (for example, to-be-trained neural network model) is located. Similarly, the computing device 120 may generate the input component watermark by using various suitable methods based on the first input and the random seed, and the specific generation method of the input component watermark is not limited in the present disclosure.

In some embodiments, the computing device 120 may generate the gradient component watermark based on the first model gradient (for example, a gradient set for training the to-be-trained neural network model) of the neural network model (for example, the to-be-trained neural network model) and the random seed determined based on the PUF response in the device in which the to-be-trained neural network model is located. Similarly, the computing device 120 may generate the gradient component watermark by using various suitable methods based on the first model gradient and the random seed, and the specific generation method of the gradient component watermark is not limited in the present disclosure.

After generating the parameter component watermark, the input component watermark, and the gradient component watermark, the computing device 120 may embed the generated parameter component watermark, input component watermark, and gradient component watermark into the first parameter, the first input, and the first model gradient of the to-be-trained neural model respectively according to the method 200 in the flow chart illustrated in FIG. 2, so as to generate the second parameter, the second input, and the second model gradient, respectively. The computing device 120 may further train the neural network model based on the generated second parameter, second input, and second model gradient to generate the trained neural network model 122. As a result, the trained neural network model 122 generated has split component watermarks embedded, so that protection on the neural network model 122 may be achieved.

An example implementation of the computing device 120 performing watermark extraction on the to-be-verified neural network model 126 to perform verification on the model will be described below.

As shown in FIG. 1, the attacker 160 attacks the neural network model (the trained neural network model 122 or another network model), such as tampering with the model or stealing the model, and generates the to-be-verified neural network model 126. In some embodiments, the computing device 120 may receive an attack indicator as well as output data and a network parameter (for example, as a to-be-verified network parameter) of the to-be-verified neural network model 126, and determine a verification mode by using the adaptive controller 124 in the computing device 120. In some embodiments, the output data includes a predicted output generated by the to-be-verified neural network model 126 for given input data. The network parameter includes model parameters of the to-be-verified neural network model 126, such as the weight and the bias. The attack indicator indicates whether there is an attack and an attack type when there is an attack.

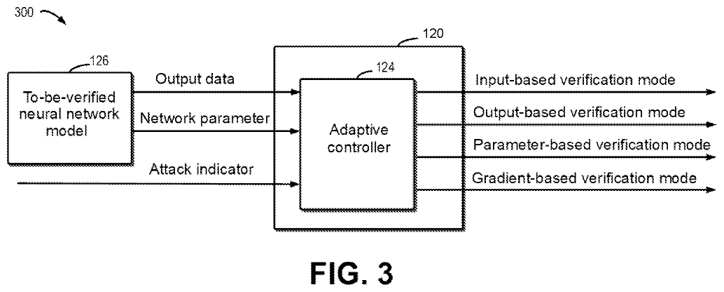

The specific implementation process of determining a verification mode according to the adaptive controller 124 will be described below with reference to FIG. 3. FIG. 3 is a schematic diagram 300 of determining a verification mode by using an adaptive controller 124 according to an embodiment of the present disclosure. In one embodiment, the adaptive controller 124 may be located in the computing device 120. In some embodiments, the computing device 120 may receive output data predicted by the to-be-verified neural network model 126 for input data, and input the output data to the adaptive controller 124. The output data may be output data obtained by inputting the input data into the to-be-verified neural network model 126. The computing device 120 may further receive the network parameter of the to-be-verified neural network model 126 as the to-be-verified network parameter, and input the received network parameter into the adaptive controller 124. In addition, the computing device 120 may further receive the attack indicator and input the received attack indicator to the adaptive controller 124. In some embodiments, the attack indicator indicates whether there is an attack and the attack type when there is an attack. Examples of the attack type may include, but are not limited to, a model inversion attack, a model compression attack, a model fine-tuning attack, a model cloning attack, and the like.

In some embodiments, the adaptive controller 124 may generate a decision vector according to the received attack indicator and the output data and network parameter of the to-be-verified neural network model 126, so as to determine a verification mode by the computing device 120. The determined verification mode is used for verifying the ownership of the to-be-verified neural network model 126 by verifying the watermark of the model. In some embodiments, as shown in FIG. 3, the verification mode includes at least one of an input-based verification mode, an output-based verification mode, a parameter-based verification mode, or a gradient-based verification mode. The decision vector output by the adaptive controller 124 is used for indicating a verification mode that may be used in the watermark verification process. Taking the verification mode illustrated in FIG. 3 as an example, the decision vector may include four elements, representing an input-based verification mode, an output-based verification mode, a parameter-based verification mode, or a gradient-based verification mode, respectively. The adaptive controller 124 may generate, for each element, a confidence coefficient representing adoption of the element, represented by a value between 0 and 1.

The computing device 120 may acquire the decision vector output by the adaptive controller 124 and determine the verification mode according to values of the elements in the decision vector. For example, the computing device 120 may select the element with the maximum value and determine the verification mode corresponding to the element as the verification mode used when the to-be-verified neural network model is verified.

In some embodiments, the adaptive controller 124 may be implemented by using a recurrent neural network (RNN). The adaptive controller 124 may be trained by using a reinforcement learning method. A reward function may be defined as a combination of a security index and a performance index. The security index may measure the ability of a watermark to resist different types of attacks (e.g., the model inversion attack, the model compression attack, the model fine-tuning attack, and the model cloning attack). The performance index may be used to measure the ability of a model to maintain its original functionality and accuracy. The reward function aims to balance the two aspects to protect the integrity of the model to the maximum extent.

In the training process, the RNN decision-making function is adjusted according to reward feedback. For example, if the RNN detects a model inversion attack, the RNN may be given the maximum reward, for example, +1, when the RNN is switched to the gradient-based watermark verification mode. If the RNN detects a model compression attack, the RNN may be given the maximum reward, for example, +1, when the RNN is switched to the parameter-based watermark verification mode. If the RNN detects a model fine-tuning attack, the RNN may be given the maximum reward, for example, +1, when the RNN is switched to the output-based watermark verification mode. If the RNN detects a model cloning attack, the RNN may be given the maximum reward, for example, +1, when the RNN is switched to the input-based watermark verification mode. The RNN is trained by using the reinforcement learning method mentioned above, and the adaptive controller 124 may be obtained. Therefore, the adaptive controller 124 can generate a decision vector according to the received attack indicator as well as the output data and the network parameter of the to-be-verified neural network model 126. The decision vector is used for determining the verification mode that may be used in the verification process of the to-be-verified neural network model 126.

As mentioned above, the computing device 120 may acquire the decision vector output by the adaptive controller 124 and determine the verification mode according to the values of the elements in the decision vector. The computing device 120 may further extract the watermark from the to-be-verified neural network model 126 as extracted data. The computing device 120 may further select, according to the determined verification mode, extracted data corresponding to the determined verification mode, and compare the selected extracted data with a PUF response in the device (such as the computing device 120 in FIG. 1) where the to-be-trained neural network model 122 is located, so as to generate a verification result.

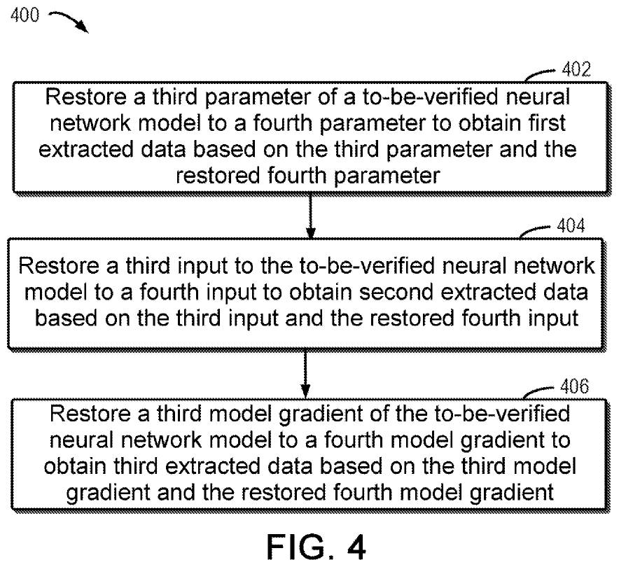

FIG. 4 is a flow chart of a method 400 for extracting a watermark of a to-be-verified neural network model 126 as extracted data according to an embodiment of the present disclosure. The method 400 may be performed at the computing device 120 in FIG. 1 and any suitable computing device. In addition, the numbering in the flow chart does not indicate the order in which these steps are performed. Some or all of these steps may be performed in parallel, or the performing order may be exchanged with each other, which is not limited in the present disclosure.

At block 402, the computing device 120 may restore a third parameter of the to-be-verified neural network model 126 to a fourth parameter to obtain first extracted data based on the third parameter and the restored fourth parameter. In some embodiments, the third parameter of the to-be-verified neural network model 126 may include the network parameter of the to-be-verified neural network model 126. The computing device 120 may restore the third parameter of the to-be-verified neural network model 126 to the fourth parameter by using an inverse operation of the parameter-based watermarking technology used when embedding the parameter component watermark into the to-be-trained neural network model. The computing device 120 may obtain the first extracted data based on the third parameter and the restored fourth parameter. The first extracted data may be used for characterizing the parameter component watermark embedded in the parameter.

For example, assuming that the third parameter of the to-be-verified neural network model 126 may be represented as P3, by performing the inverse operation of the parameter-based watermarking technology on the third parameter P3, the computing device 120 may obtain a restored fourth parameter P4 of the to-be-verified neural network model 126. The computing device 120 may determine a difference AP between the third parameter and the fourth parameter, and use the difference as the first extracted data D1 for representing the parameter component watermark embedded in the network parameter of the to-be-verified neural network model 126.

At block 404, the computing device 120 may restore a third input to the to-be-verified neural network model 126 to a fourth input to obtain second extracted data based on the third input and the restored fourth input. In some embodiments, the third input to the to-be-verified neural network model 126 may include input data of the to-be-verified neural network model 126. The computing device 120 may restore the third input to the to-be-verified neural network model 126 to the fourth input by using an inverse operation of the input-based watermarking technology used when embedding the input component watermark into the to-be-trained neural network model. The computing device 120 may obtain the second extracted data based on the input parameter and the restored fourth input. The second extracted data may be used for characterizing the input component watermark embedded in the input.

For example, assuming that the third input to the to-be-verified neural network model 126 may be represented as 13, and the computing device 120 may obtain a restored fourth input 14 of the to-be-verified neural network model 126 by performing the inverse operation of the input-based watermarking technology on the third input 13. The computing device 120 may determine a difference 4/between the third input and the fourth input, and use the difference as the second extracted data D2 to represent the input component watermark embedded in the input data of the to-be-verified neural network model 126.

At a block 406, the computing device 120 may also restore a third model gradient of the to-be-verified neural network model 126 to a fourth model gradient to obtain third extracted data based on the third model gradient and the restored fourth model gradient. In some embodiments, the third model gradient of the to-be-verified neural network model 126 may include a model gradient of the to-be-verified neural network model 126. The computing device 120 may restore the third model gradient of the to-be-verified neural network model 126 to the fourth model gradient by using an inverse operation of the gradient-based watermark technology used when embedding the gradient component watermark into the to-be-trained neural network model. The computing device 120 may obtain the third extracted data based on the model gradient parameter and the restored fourth model gradient. The third extracted data may be used for characterizing the gradient component watermark embedded in the model gradient.

For example, assuming that the third model gradient of the to-be-verified neural network model 126 may be expressed as G3, and the computing device 120 may obtain a restored fourth model gradient G4 of the to-be-verified neural network model 126 by performing the inverse operation of the gradient-based watermarking technology on the third model gradient G3. The computing device 120 may determine a difference AG between the third model gradient and the fourth model gradient, and use the difference as the third extracted data D3 to represent the gradient component watermark embedded in model gradient data of the to-be-verified neural network model 126.

Furthermore, it is to be understood that in the case where the split component watermarks include the output component watermark, the computing device 120 may further restore a third output from the to-be-verified neural network model 126 to a fourth output to obtain fourth extracted data based on the third output and the restored fourth output. In some embodiments, the third output degree from the to-be-verified neural network model 126 may include a predicted output from the to-be-verified neural network model 126 under given input data. The computing device 120 may restore the third output from the to-be-verified neural network model 126 to the fourth output by using an inverse operation of the output-based watermarking technology used when embedding the output component watermark into the to-be-trained neural network model. The computing device 120 may obtain the fourth extracted data based on the output parameter and the restored fourth output. The fourth extracted data may be used for characterizing the output component watermark embedded in the output.

For example, assuming that the third output from the to-be-verified neural network model 126 may be represented as U3, and the computing device 120 may obtain a restored fourth output U4 from the to-be-verified neural network model 126 by performing the inverse operation of the output-based watermarking technology on the third output U3. The computing device 120 may determine a difference AU between the third output and the fourth output, and use the difference as the fourth extracted data D4 to represent the output component watermark embedded in the output data of the to-be-verified neural network model 126.

In some embodiments, after determining the verification mode according to the decision vector of the adaptive controller 124, the computing device 120 may further select, based on the determined verification mode, the extracted data corresponding to the determined verification mode from the first extracted data, the second extracted data, and the third extracted data. For example, when the computing device 120 determines that the verification mode is the parameter-based verification mode, the computing device 120 may select the first extracted data D1. When the computing device 120 determines that the verification mode is the input-based verification mode, the computing device 120 may select the second extracted data D2. When the computing device 120 determines that the verification mode is the gradient-based verification mode, the computing device 120 may select the third extracted data D3. Furthermore, it is to be understood that when the computing device 120 determines that the verification mode is the output-based verification mode, the computing device 120 may select the fourth extracted data D4.

After selecting the extracted data (that is, the corresponding component watermark), the computing device 120 may compare the selected extracted data with the PUF response in the device where the to-be-trained neural network model is located (for example, the computing device 120 in FIG. 1), so as to verify the to-be-verified neural network model 126, for example, confirming whether the ownership of the to-be-verified neural network model 126 is owned by the owner of the neural network model 122. In some embodiments, when the computing device 120 determines that the extracted data matches the PUF response, the computing device 120 may determine that the ownership of the to-be-verified neural network model 126 is owned by the owner of the neural network model 122. Correspondingly, the computing device 120 may determine that the neural network model 122 is attacked and may take a corresponding measure. When the computing device 120 determines that the extracted data does not match the PUF response, the computing device 120 may determine that the ownership of the to-be-verified neural network model 126 is not owned by the owner of the neural network model 122.

The method for processing a watermark of a neural network model described above effectively enhances the anti-attack ability of the neural network model, and significantly enhances the flexibility and adaptability of processing the watermark of the neural network model.

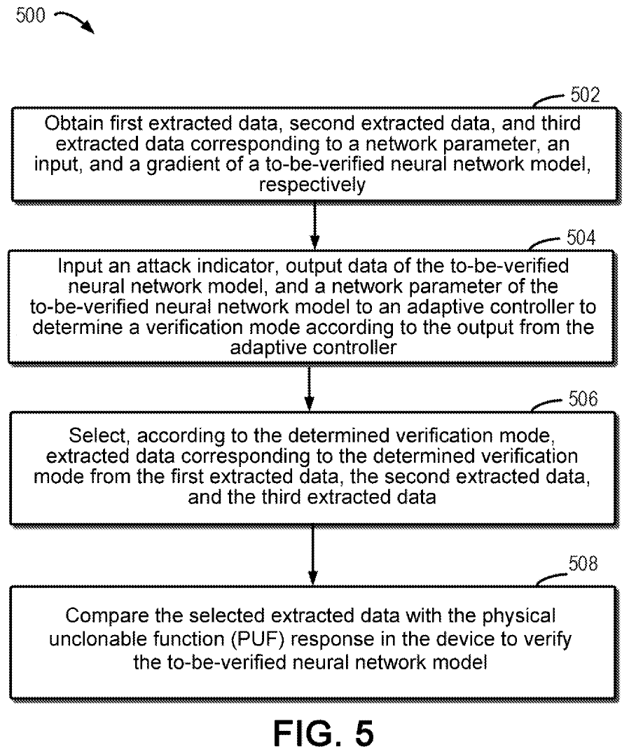

According to embodiments of the present disclosure, a method for verifying a neural network model by verifying a watermark of the model is further provided. The method for verifying a watermark of a neural network model according to an embodiment of the present disclosure is described below with reference to FIG. 5. FIG. 5 is a flow chart of a method 500 for verifying a watermark of a neural network model according to an embodiment of the present disclosure. The method 500 may be performed at the computing device 120 in FIG. 1 and any suitable computing device. In addition, the numbering in the flow chart does not indicate the order in which these steps are performed. Some or all of these steps may be performed in parallel, or the performing order may be exchanged with each other, which is not limited in the present disclosure.

At block 502, the computing device 120 may obtain first extracted data, second extracted data, and third extracted data corresponding to a network parameter, input data, and a gradient of the to-be-verified neural network model 126, respectively. In some embodiments, the computing device 120 may obtain the first extracted data D1, the second extracted data D2, and the third extracted data D3 respectively by using the method 400 for extracting a watermark from the to-be-verified neural network model 126 as extracted data described with reference to FIG. 4.

For example, the computing device 120 may restore the third parameter of the to-be-verified neural network model 126 to the fourth parameter to obtain the first extracted data D1 based on the third parameter and the restored fourth parameter, and the first extracted data D1 characterizes the parameter component watermark. The computing device 120 may restore the third input to the to-be-verified neural network model 126 to the fourth input to obtain the second extracted data D2 based on the third input and the restored fourth input, and the second extracted data D2 characterizes the input component watermark. The computing device 120 may also restore the third model gradient of the to-be-verified neural network model 126 to the fourth model gradient to obtain the third extracted data D3 based on the third model gradient and the restored fourth model gradient, and the third extracted data D3 characterizes the gradient component watermark. In addition, the computing device 120 may also restore the third output from the to-be-verified neural network model 126 to the fourth output to obtain the fourth extracted data D4 based on the third output and the restored fourth output, and the fourth extracted data D4 characterizes the output component watermark. The specific extraction process can be understood in combination with the description in FIG. 4, which is not repeated here for the sake of brevity.

At block 504, the computing device 120 may input the attack indicator as well as the output data and the network parameter of the to-be-verified neural network model 126 to the adaptive controller 124 to determine a verification mode according to the output from the adaptive controller.

As described above, the output data includes the predicted output data generated by the to-be-verified neural network model 126 for given input data. The network parameter includes parameters of the to-be-verified neural network model 126, such as the weight and the bias. The attack indicator indicates whether there is an attack and the attack type when there is an attack. Examples of the attack type may include, but are not limited to, a model inversion attack, a model compression attack, a model fine-tuning attack, a model cloning attack, and the like.

The verification mode may include at least one of an input-based verification mode, an output-based verification mode, a parameter-based verification mode, or a gradient-based verification mode. In some embodiments, the adaptive controller 124 can generate a decision vector according to the received attack indicator as well as the output data and the network parameter of the to-be-verified neural network model 126. The decision vector is used for determining the verification mode that may be used in the verification process of the watermark. The computing device 120 may acquire the decision vector output by the adaptive controller 124 and determine the verification mode according to values of the elements in the decision vector. The steps at block 504 may be implemented with reference to the detailed description in FIG. 3, which is not repeated here for the sake of brevity.

At block 506, the computing device 120 may select, according to the determined verification mode, the extracted data corresponding to the determined verification mode from the first extracted data, the second extracted data, and the third extracted data. For example, when the computing device 120 determines that the verification mode is the parameter-based verification mode, the computing device 120 selects the first extracted data D1 that characterizes the parameter component watermark. When the computing device 120 determines that the verification mode is the input-based verification mode, the computing device 120 selects the second extracted data D2 that characterizes the input component watermark. When the computing device 120 determines that the verification mode is the gradient-based verification mode, the computing device 120 selects the third extracted data D3 that characterizes the gradient component watermark. Furthermore, it is to be understood that when the computing device 120 determines that the verification mode is the output-based verification mode, the computing device 120 may select the fourth extracted data D4 that characterizes the output component watermark.

At block 508, the computing device 120 may compare the selected extracted data with the PUF response in the device to verify the to-be-verified neural network model, for example, confirming whether the ownership of the to-be-verified neural network model 126 is owned by the owner of the neural network model 122. In some embodiments, the device may be a device where a to-be-trained neural network corresponding to the neural network model 122 is located. In other words, the computing device 120 may compare the selected extracted data with the PUF response in the device where the to-be-trained neural network model corresponding to the to-be-compared neural network model is located, so as to verify the to-be-verified neural network model. In some embodiments, when the computing device 120 determines that the extracted data matches the PUF response, the computing device 120 may determine that the ownership of the to-be-verified neural network model 126 is owned by the owner of the neural network model 122. Correspondingly, the computing device 120 may determine that the neural network model 122 is attacked, and a corresponding measure may then be taken. When the computing device 120 determines that the extracted data does not match the PUF response, the computing device 120 may determine that the ownership of the to-be-verified neural network model 126 is not owned by the owner of the neural network model 122.

In some embodiments, the neural network model 122 is obtained after training the to-be-trained neural network model. The split component watermarks may be embedded into the to-be-trained neural network model by the following operations: generating a second parameter of the to-be-trained neural network model by embedding the parameter component watermark into a first parameter of the to-be-trained neural network model; generating a second input to the to-be-trained neural network model by embedding the input component watermark into a first input to the to-be-trained neural network model; generating a second model gradient of the to-be-trained neural network model by embedding the gradient component watermark into a first model gradient of the to-be-trained neural network model; and training the to-be-trained neural network model based on the second parameter, the second input, and the second model gradient to generate the trained neural network model 122.

In some embodiments, a random seed may be determined based on the PUF response in the device where the to-be-trained neural network model is located. In some embodiments, the random seed is used for generating the parameter component watermark, the input component watermark, and the gradient component watermark.

In some embodiments, the parameter component watermark may be generated based on the first parameter of the to-be-trained neural network model and the determined random seed. In some embodiments, the input component watermark may be generated based on the first input to the to-be-trained neural network model and the determined random seed. In some embodiments, the gradient component watermark may be generated based on the first model gradient of the to-be-trained neural network model and the determined random seed. In addition, the output component watermark may further be generated based on the first output from the to-be-trained neural network model and the determined random seed.

The operating process of embedding watermarks and the process of generating split component watermarks for the to-be-trained neural network model are basically the same as the corresponding processes described above, which will not be repeated here for the sake of brevity.

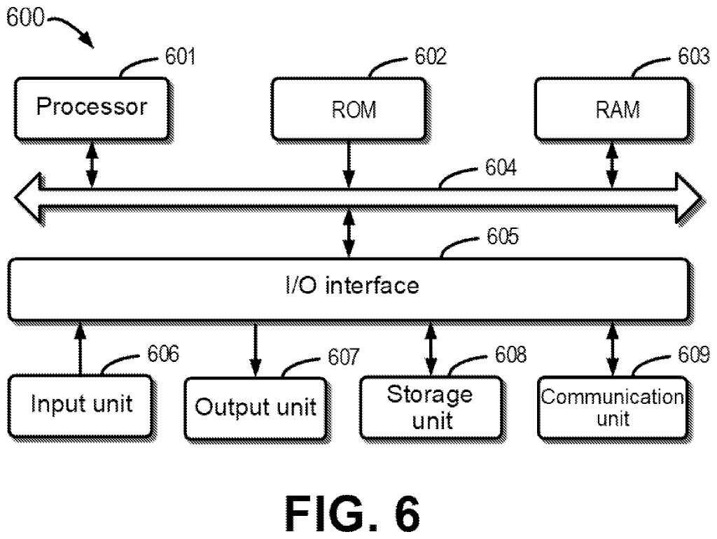

FIG. 6 shows a block diagram of an example device 600 that may be used to implement embodiments of the present disclosure. For example, the computing device 120 in FIG. 1 can be implemented by using the device 600. As shown in the figure, the device 600 includes a central processing unit (CPU) 601 that may execute various appropriate actions and processing according to computer program instructions stored in a read-only memory (ROM) 602 or computer program instructions loaded from a storage unit 608 to a random access memory (RAM) 603. Various programs and data required for the operation of the device 600 may further be stored in the RAM 603. The CPU 601, the ROM 602, and the RAM 603 are connected to each other through a bus 604. An input/output (I/O) interface 605 is also connected to the bus 604.

A plurality of components in the device 600 are connected to the I/O interface 605 and include: an input unit 606, such as a keyboard and a mouse; an output unit 607, such as various types of displays and speakers; the storage unit 608, such as a magnetic disk and an optical disc; and a communication unit 609, such as a network card, a modem, and a wireless communication transceiver. The communication unit 609 allows the device 600 to exchange information/data with other devices via a computer network, such as the Internet, and/or various telecommunication networks.

The various processes and processing described above, such as the method 200 for processing watermarks of a neural network model, the method 400 for extracting watermarks from a to-be-verified neural network model as extracted data, and the method 500 for verifying watermarks of a neural network model, can be executed by the CPU 601. For example, in some embodiments, the methods 200, 400, and 500 may be implemented as a computer software program that is tangibly included in a machine-readable medium such as the storage unit 608. In some embodiments, part of or all the computer program may be loaded and/or installed onto the device 600 via the ROM 602 and/or the communication unit 609. When the computer program is loaded into the RAM 603 and executed by the CPU 601, one or more actions of the method 200 for processing watermarks of a neural network model, the method 400 for extracting watermarks from a to-be-verified neural network model as extracted data, and the method 500 for verifying watermarks of a neural network model may be executed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, another programmable data processing apparatus, or another device, so that a series of operating steps can be performed on the computer, the other programmable data processing apparatus, or the other device to produce a computer-implemented process, such that the instructions executed on the computer, the other programmable data processing apparatus, or the other device can implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method comprising:
embedding a parameter component watermark into a first parameter of a neural network model to generate a second parameter of the neural network model;
embedding an input component watermark into a first input to the neural network model to generate a second input to the neural network model;
embedding a gradient component watermark into a first model gradient of the neural network model to generate a second model gradient of the neural network model; and
training the neural network model based on the second parameter, the second input, and the second model gradient to generate a trained neural network model.

2. The method according to claim 1, further comprising:
determining a random seed based on a physical unclonable function response in a device where the neural network model is located, wherein the random seed is used for generating the parameter component watermark, the input component watermark, and the gradient component watermark.

3. The method according to claim 2, further comprising:
generating the parameter component watermark based on the first parameter of the neural network model and the random seed;
generating the input component watermark based on the first input to the neural network model and the random seed; and
generating the gradient component watermark based on the first model gradient of the neural network model and the random seed.

4. The method according to claim 1, further comprising:
acquiring output data of a to-be-verified neural network model for input data.

5. The method according to claim 4, wherein the to-be-verified neural network model comprises a to-be-verified network parameter, and the method further comprises:
inputting the output data, the to-be-verified network parameter, and an attack indicator to an adaptive controller to determine a verification mode based on an output from the adaptive controller, wherein the verification mode is used for verifying the to-be-verified neural network model.

6. The method according to claim 5, wherein the adaptive controller is implemented by using a recurrent neural network (RNN).

7. The method according to claim 5, wherein the verification mode comprises at least one of an input-based verification mode, an output-based verification mode, a parameter-based verification mode, or a gradient-based verification mode.

8. The method according to claim 5, further comprising:
restoring a third parameter of the to-be-verified neural network model to a fourth parameter to obtain first extracted data based on the third parameter and the restored fourth parameter;
restoring a third input to the to-be-verified neural network model to a fourth input to obtain second extracted data based on the third input and the restored fourth input; and
restoring a third model gradient of the to-be-verified neural network model to a fourth model gradient to obtain third extracted data based on the third model gradient and the restored fourth model gradient.

9. The method according to claim 8, further comprising:
selecting, based on the determined verification mode, extracted data corresponding to the determined verification mode from the first extracted data, the second extracted data, and the third extracted data; and
comparing the selected extracted data with a physical unclonable function response in a device where the neural network model is located, so as to verify the to-be-verified neural network model.

10. The method according to claim 5, wherein the attack indicator is used for indicating whether there is an attack and an attack type if there is an attack.

11. An electronic device, comprising:
at least one processor; and
a memory coupled to the at least one processor and having instructions stored therein, wherein the instructions, when executed by the at least one processor, cause the electronic device to perform actions comprising:
embedding a parameter component watermark into a first parameter of a neural network model to generate a second parameter of the neural network model;
embedding an input component watermark into a first input to the neural network model to generate a second input to the neural network model;
embedding a gradient component watermark into a first model gradient of the neural network model to generate a second model gradient of the neural network model; and
training the neural network model based on the second parameter, the second input, and the second model gradient to generate a trained neural network model.

12. The electronic device according to claim 11, wherein the instructions, when executed by the at least one processor, further cause the electronic device to perform actions comprising:
determining a random seed based on a physical unclonable function response in a device where the neural network model is located, wherein the random seed is used for generating the parameter component watermark, the input component watermark, and the gradient component watermark.

13. The electronic device according to claim 12, wherein the instructions, when executed by the at least one processor, further cause the electronic device to perform actions comprising:
generating the parameter component watermark based on the first parameter of the neural network model and the random seed;
generating the input component watermark based on the first input to the neural network model and the random seed; and
generating the gradient component watermark based on the first model gradient of the neural network model and the random seed.

14. The electronic device according to claim 11, wherein the instructions, when executed by the at least one processor, further cause the electronic device to perform actions comprising:
acquiring output data of a to-be-verified neural network model for input data.

15. The electronic device according to claim 14, wherein the to-be-verified neural network model comprises a to-be-verified network parameter, and wherein the instructions, when executed by the at least one processor, further cause the electronic device to perform actions comprising:
inputting the output data, the to-be-verified network parameter, and an attack indicator to an adaptive controller to determine a verification mode based on an output from the adaptive controller, wherein the verification mode is used for verifying the to-be-verified neural network model.

16. The electronic device according to claim 15, wherein the adaptive controller is implemented by using a recurrent neural network (RNN).

17. The electronic device according to claim 15, wherein the verification mode comprises at least one of an input-based verification mode, an output-based verification mode, a parameter-based verification mode, or a gradient-based verification mode.

18. The electronic device according to claim 15, wherein the instructions, when executed by the at least one processor, further cause the electronic device to perform actions comprising:
restoring a third parameter of the to-be-verified neural network model to a fourth parameter to obtain first extracted data based on the third parameter and the restored fourth parameter;
restoring a third input to the to-be-verified neural network model to a fourth input to obtain second extracted data based on the third input and the restored fourth input; and
restoring a third model gradient of the to-be-verified neural network model to a fourth model gradient to obtain third extracted data based on the third model gradient and the restored fourth model gradient.

19. The electronic device according to claim 18, wherein the instructions, when executed by the at least one processor, further cause the electronic device to perform actions comprising:
selecting, based on the determined verification mode, extracted data corresponding to the determined verification mode from the first extracted data, the second extracted data, and the third extracted data; and
comparing the selected extracted data with a physical unclonable function response in the device where the neural network model is located, so as to verify the to-be-verified neural network model.

20. A computer program product, the computer program product being tangibly stored on a non-transitory computer-readable medium and comprising machine-executable instructions, wherein the machine-executable instructions, when executed by a machine, cause the machine to perform actions comprising:
embedding a parameter component watermark into a first parameter of a neural network model to generate a second parameter of the neural network model;
embedding an input component watermark into a first input to the neural network model to generate a second input to the neural network model;
embedding a gradient component watermark into a first model gradient of the neural network model to generate a second model gradient of the neural network model; and
training the neural network model based on the second parameter, the second input, and the second model gradient to generate a trained neural network model.
